(19) United States
(12) Patent Application Publication
(10) Pub. No.: US 2009/0109301 A1
(43) Pub. Date: Apr. 30, 2009

(54) IMAGE CAPTURING DEVICE

(75) Inventor: Jie-Yan Ke, Foshan (CN)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/124,869

(22) Filed: May 21, 2008

(30) Foreign Application Priority Data
Oct. 26, 2007 (CN) 200710202282.3

(51) Int. Cl. H04N 5/765

(52) U.S. Cl. 348/231.5; 348/E05.007

(57) ABSTRACT

An image capturing includes an imaging sensor for capturing images, a display unit for displaying the images, a storage unit for storing the images, a key unit for a user to input at least one characteristic of an image stored in the storage unit, a user input processing unit for receiving and decoding the at least one characteristic from the key unit, and a digital signal processor. The digital signal processor receives the at least one decoded characteristic from the user input processing unit, determines a plurality of the images matching the at least one characteristic, and causes the images to be displayed representatively in the display unit.

### BACKGROUND

1. Field of the Invention

The present invention relates to imaging technology, and particularly, to an image capturing device.

2. Description of Related Art

Image capturing devices, such as digital still cameras and camcorders, are popular with consumers. In cases where a consumer has purchased an image capturing device having a significant amount of memory, or a memory stick, the image capturing device may be capable of storing hundreds of images. In these circumstances, when the user attempts to find and view a particular image or series of images, it can be difficult to locate such image(s) among the hundreds of images.

What is needed, therefore, is to provide an image capturing device, in which a particular image or a series of images can be easily found.

### SUMMARY

An image capturing device according to one embodiment includes an imaging sensor for capturing images, a display unit for displaying the images, a storage unit for storing the images, a key unit for a user to input at least one characteristic of an image stored in the storage unit, a user input processing unit for receiving and decoding the at least one characteristic from the key unit, and a digital signal processor. The digital signal processor receives the at least one decoded characteristic from the user input processing unit, determines a plurality of the images matching the at least one characteristic, and causes the images to be displayed representatively in the display unit.

Other advantages and novel features of the present invention will become more apparent from the following detailed description of exemplary embodiments when taken in conjunction with the accompanying drawings, in which:

### BRIEF DESCRIPTION OF THE DRAWINGS

FIG. 1 shows a functional diagram of modules of an image capturing device in accordance with a first exemplary embodiment;

FIG. 2 shows a user interface of the image capturing device of FIG. 1;

FIG. 3 shows key words input by a user in the user interface of FIG. 2; and

FIG. 4 is a flowchart of a method for displaying a digital image according to a second exemplary embodiment.

### DETAILED DESCRIPTION OF THE EMBODIMENTS

Reference will now be made to the figures to describe at least one exemplary embodiment in detail.

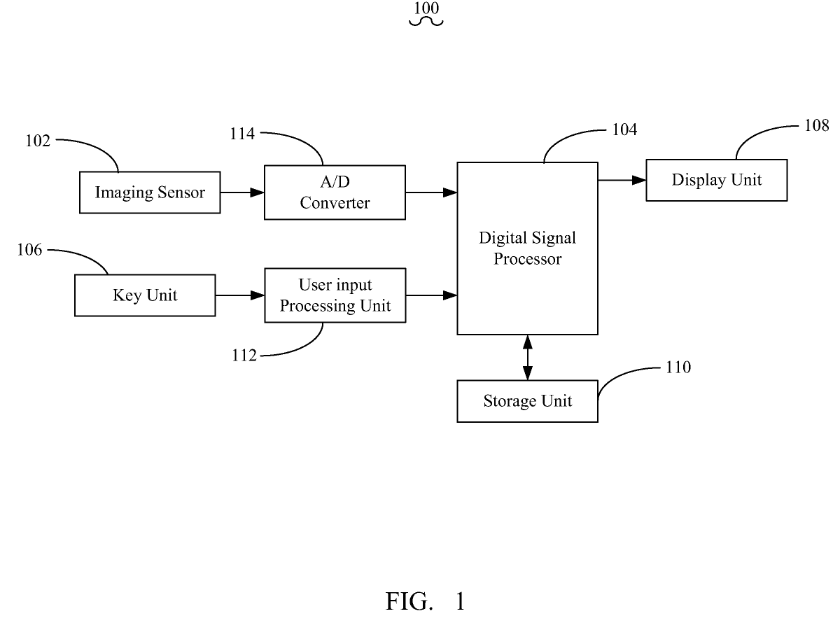

Referring to FIG. 1, an image capturing device 100, according to an exemplary embodiment, is shown. The image capturing device 100 includes an imaging sensor 102, a digital signal processor 104 (DSP), a key unit 106, a display unit 108, a storage unit 110, and a user input processing unit 112. The imaging sensor 102, such as a charge coupled device (CCD) sensor or a complementary metal-oxide semiconductor (CMOS) sensor, is coupled to the DSP 104. The DSP 104 performs operations on digital data, and therefore an analog-to-digital (A/D) converter 114 may be coupled between the imaging sensor 102 and the DSP 104. It is to be understood that the A/D converter 114 could be a stand-alone device coupled between the imaging sensor 102 and the DSP 104, or that the DSP 104 could have an on-board A/D converter to perform this function.

Images captured by the imaging sensor 102 are stored in the storage unit 110 according to an image-data table (see Table 1) pre-installed in the DSP 104. The storage unit 110 can be an internal storage media or an external storage media of the image capturing device 100. The image-data table (Table 1) comprises a plurality of preset headings for categorizing characteristics of each image stored in the storage unit 110. In this embodiment, the headings include: image number, image name, date of capture, and class. Examples of ‘class’ include numbers 1 to 3, which may indicate a degree to which the user likes the image, namely a preference rating.

TABLE 1

| Image No. | Name | Date of Capture | Class |
|---|---|---|---|
| 1 | PIC001 | 2007/1/12 | 3 |
| 2 | PIC021 | 2007/4/23 | 1 |
| 3 | PIC036 | 2007/5/1 | 2 |
| 4 | PIC045 | 2007/5/28 | 1 |
| . . . | . . . | . . . | . . . |

The key unit 106 includes a plurality of input keys for a user to operate the image capturing device 100 according to user input. When the user inputs a characteristic, or characteristics, for the image(s) he wants to browse using the key unit 106, the key unit 106 correspondingly communicates with the user input processing unit 112.

The user input processing unit 112 is coupled to the key unit 106 and is configured for receiving and decoding the user input and transmitting the decoded user input, such as a decoded characteristic, to the DSP 104. The user input may include one or more of the characteristics.

The DSP 104 receives the decoded user input, determines which image(s) stored in the storage unit 110 most nearly matches the characteristics, and causes the display unit 108, such as a liquid crystal display, to display the images representatively, e.g. in a list fashion or in a grid fashion.

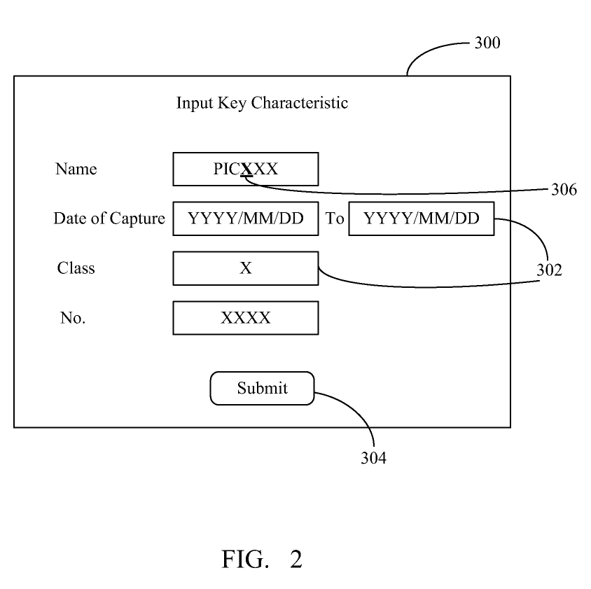

Referring to FIG. 2, an exemplary user interface 300 of the image capturing device 100 appearing on the display unit 108 is shown. The user interface 300 includes a plurality of frames 302 and a virtual function key 304, e.g. a “submit” key. Each frame 302 corresponds to a preset heading in the image-data table mentioned above. A cursor 306 is moved between the plurality of frames 302 or different character positions in one of the plurality of frames 302 by the user. The user can input characteristics in one frame 302 at a time, such as an image name in the “Name” frame 302.

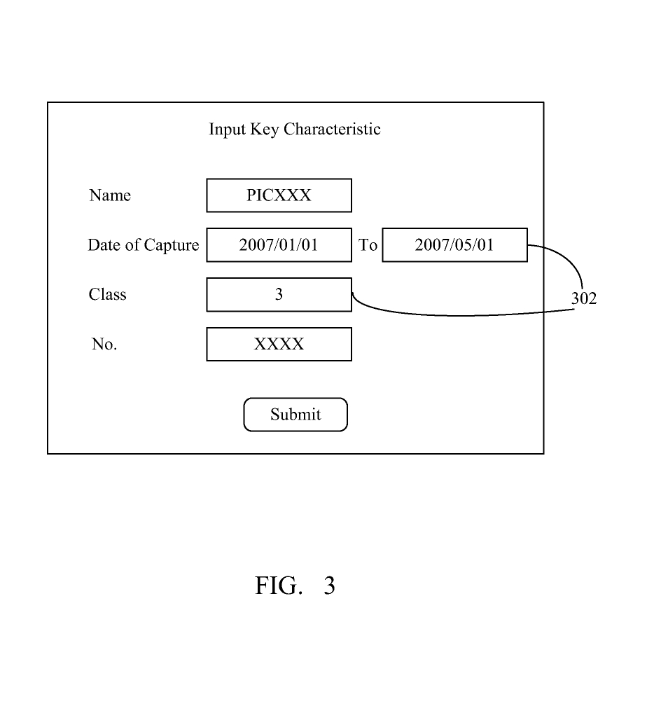

Referring to FIGS. 1 and 3, when the user wants to browse class-3 images captured from Jan. 1, 2007 to May 1, 2007, the user inputs “2007/01/01” and “2007/05/01” in the “Date of Capture” frame 302, and “3” in the “Class” frame 302, and then submits using the key unit 106. The user input processing unit 112 receives and decodes the user input from the key unit 106, then transmits the decoded user input to the DSP 104. The DSP 104 receives the decoded user input, determines that the image “PIC001” fits the user input characteristics, and causes the image “PIC001” to be displayed by the display unit 108. Thus, a user may easily find and view any image or group of images from among hundreds stored in the memory of an image capturing device.

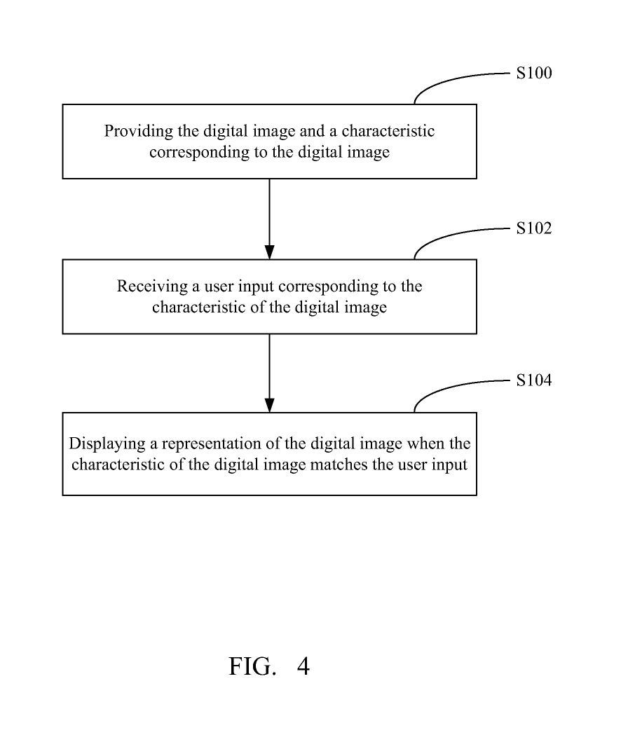

Referring to FIG. 4, a method for displaying a digital image includes the steps of: providing the digital image and a characteristic corresponding to the digital image (S100); receiving a user input corresponding to the characteristic of the digital image (S102); and displaying a representation of the digital image when the characteristic of the digital image matches the user input (S104).

In step S100, the digital image is pre-stored in the storage unit 110 with the characteristic according to the Table 1. In step S102, a user may input a characteristic using the key unit 106. The key unit 106 correspondingly communicates with the user input processing unit 112. The user input may be a date of capture, a range of dates of capture or a preference rating.

In step S104, the user input processing unit 112 decodes the user input and transmits the decoded user input to the DSP 104. The DSP 104 receives the decoded user input, determines which digital image stored in the storage unit 110 most nearly matches the characteristic, and causes the display unit 108 to display the digital image representatively, e.g. in a list fashion or in a grid fashion. In this way, the digital image the user want to browse may be easily found.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An image capturing device comprising:
an imaging sensor for capturing images;
a display unit for displaying the images;
a storage unit for storing the images;
a key unit for a user to input at least one characteristic of an image stored in the storage unit;
a user input processing unit for receiving and decoding the at least one characteristic from the key unit; and
a digital signal processor for receiving the at least one decoded characteristic from the user input processing unit, determining a plurality of the images matching the at least one characteristic, and causing the images to be displayed representatively in the display unit.

2. The image capturing device as claimed in claim 1, wherein the imaging sensor is one of a charge coupled device sensor and a complementary metal-oxide semiconductor sensor.

3. The image capturing device as claimed in claim 1, wherein an analog-to-digital converter is coupled between the imaging sensor and the digital signal processor.

4. The image capturing device as claimed in claim 1, wherein an image data table comprising a plurality of preset headings for categorizing characteristics of each image stored in the storage unit is pre-installed in the digital signal processor.

5. The image capturing device as claimed in claim 4, wherein the plurality of preset headings includes image number, image name, date of capture, and class of image.

6. The image capturing device as claimed in claim 1, wherein the display unit is a liquid crystal display.

7. A method of displaying a digital image, the method comprising:
providing the digital image and a characteristic corresponding to the digital image;
receiving a user input corresponding to the characteristic of the digital image; and
displaying a representation of the digital image when the characteristic of the digital image matches the user input.

8. The method as claimed in claim 7, wherein receiving the user input is receiving a date of capture.

9. The method as claimed in claim 7, wherein receiving the user input is receiving a range of dates of capture.

10. The method as claimed in claim 9, wherein displaying the representation of the digital image when the characteristic of the digital image matches the user input is displaying the representation of the digital image when a date of capture of the digital image falls within the range of dates of capture.

11. The method as claimed in claim 7, wherein receiving the user input is receiving a preference rating.
